(19) United States
(12) Patent Application Publication
(10) Pub. No.: US 2005/0284357 A1
(43) Pub. Date: Dec. 29, 2005

(54) Flagpole accessories

(76) Inventors: Behruz Vazvan, Helsinki (FI); Sara Vazvan, Laguna Beach, CA (US)

Correspondence Address: Sara Vazvan, Suite # 173, 668 North Pacific Cost Hwy, Laguna Beach, CA, 92651, US

(21) Appl. No.: 11/158,121

(22) Filed: Jun. 21, 2005

(30) Foreign Application Priority Data
Aug. 16, 2004 (FI) 20041078
Jun. 28, 2004 (FI) 20040882
Aug. 23, 2004 (FI) 20041101

(51) Int. Cl. G09F 17/00

(52) U.S. Cl. 116/173

(57) ABSTRACT

This invention relates to flagpoles (23, 33) and their accessories (1, 8, 19, 21). In one of its objects this invention relates to flag illumination solution (1, 8) arranged with a smart flag rope (1) including at least an electricity cable (2) to transfer the required electricity power to the illuminator or other devices used in connection with said rope (1) over the flagpole. In another object the present invention relates to devices such as flag illuminator (8), flag waver (19), flagpole cleaning device (21) etc. comprising means to allow them to be used at least in one of their embodiments in connection with said smart flag rope (1). Yet in another object this invention relates to a new type of flagpole (33, 34) made of elastic and flexible materials like plastic or rubber overcoming the manufacturing, transportation and installation of known traditional flagpoles.

### BACKGROUND OF THE INVENTION

1. Field of the Invention

This invention relates to flagpoles and their accessories. In one of its objects this invention relates to flag rope. In another object this invention relates to easily use of electrical or electronic etc. devices with flagpole. Yet in another object the present invention relates to the flag illumination. Yet in another object this invention relates to a cleaning device for flagpoles. Yet in another object this invention relates to a flag waver. Yet in another object this invention relates to a new type of flagpole.

2. Background Art

Various flags, such as national, advertising and organizational flags, and pennants flying on flagpoles are generally poorly or not at all visible in the dark. It is however often desired that flags and pennants be visible at any time of the day or night and at any time of the year, and therefore floodlights have sometimes been used to improve their visibility. Depending on the voltage range used, floodlight installations are, however, subject to licensing. In addition, floodlights are often difficult to use, and the investment and operating costs of the necessary equipment may be very high.

Various solutions relating to flag-pole lights have been disclosed in the prior art. German Offenlegungsschrift No. 39 18169 discloses a separate rotating light to be mounted at the top of a flag-pole by fixing it to a rotating outer tube of the flag-pole, to which the flag is also attached. The flag, the outer tube and the light thus rotate with the wind. This solution requires that separate equipment be installed in the flag-pole. Finnish Patent Application No. 881,266 discloses a transparent tube which contains lighting equipment and which is to be mounted at the top of a flagpole. This solution involves mounting a separate element as an extension or part of a flag-pole. U.S. Pat. No. 3,752,975 discloses a solution for illuminating a flag flying on a flag-pole. The flagpole is surmounted by a lamp unit comprising an upwardly tapered canopy which comprises a shade supported upon legs. The upper end of the shade is provided with a lamp socket to which a downwardly extending spot light lamp is attached. Electrical wires extend along the legs and further along the pole to a timer. This solution, too, is complicated with its legs and separate shade. U.S. Pat. No. 6,227,683 which is a continuation of Finnish patent FI1100205 provides a light at the top of flag-poles by replacing a normal non-luminous flag-pole knob with a luminous knob. Even this solution requires that separate equipment i.e. luminous knob be installed on the top of the flag-pole. In addition to the above-mentioned, there have been attempts to illuminate a flag-pole by means of other separate lighting systems mounted on the flag-pole or at its top. All of these solutions are difficult to implement, they are not easily applicable to existing flag-poles, and it is not profitable to manufacture them in series.

These and other problems were taken into account in the development of the present invention. It will be seen that not only does the present invention make it easier for people e.g. to display the national and other flags at dark time, but it does so at smaller cost, less bother and greater overall energy and money savings than comparable solutions in the past.

Furthermore, various devices and solutions are provided for especially painting flagpoles. Few examples of such devices are presented in U.S. Pat. No. 3,344,773 (Flag pole painter), U.S. Pat. No. 4,095,555 (Painting device for flagpoles), U.S. Pat. No. 2,998,801 (Device for painting flagpoles, suspension cables and the like), U.S. 2,357,144 (Surface treating apparatus for poles). Also other solutions relating to handling and painting of suspension cables on various bridges, and how to treat and clean telephone poles, and various long suspended wires and cables are already provided. An example of such complicated device is presented in U.S. Pat. No. 2,858,555 (Self-propelled cleaning or painting device) and U.S. Pat. No. 3,116,811 (Portable cable cleaner and lubricator). Such devices are very complicated and expensive to manufacture in series. However such solutions are not related to flagpoles. All of the above-mentioned solutions require complicated and expensive equipment that are also difficult to manufacture in series and economically. No one of the existing solutions is arranged for cleaning and shining of flagpoles as the present invention does.

Moreover, traditionally, flagpoles are usually made off metal, plastic or fibreglasses, or wood. The problem with such poles is mostly their cost of manufacturing, installations etc. To overcome these problems one object of the present invention is to provide a new type of flagpole.

To overcome all above-mentioned problems the present inventions provide with different alternative solutions that are efficient, economical and do not need to lower the heavy flagpoles in order to arrange e.g. illuminators etc. for them. The present inventions also provide several inventive advantages that have not been disclosed before.

### SUMMARY OF THE INVENTION

An object of the invention is to provide a flag illuminating solution which can be arranged and used without difficulty in both existing poles and in new poles manufactured in series without any need to install the light or its equipment to the flagpole permanently. It is a principal object of the invention to provide a flag illumination solution that receives the required power feed via a smart flag rope allowing the lighting source to move along with the flag up-down when the flag is risen or lowered. It is another advantage of the present invention to allow the lighting source to be easily lowered along with the flag in order to allow a person to e.g. change the burned bulb etc. without any need to lower the flagpole. Through the present invention an efficient lighting of the flag is obtained without any need to mount the lighting source to the flagpole permanently.

It is another object of the present invention to provide a flagpole cleaning device that can be very easily used to clean and shine flagpoles. Yet it is another object of the present invention to overcome the problems of manufacturing, installations etc. of traditional flagpoles by introducing a new type of flagpole.

The present inventions are also very simple to arrange. Other objects and advantages will become apparent from the following description, in which reference is made to the accompanying drawings. The solutions of the present inventions have not been disclosed previously.

### BRIEF DESCRIPTION OF THE DRAWINGS

FIG. 1 is an example schematic of the inventive smart flag rope, lighting source, and the flag waver.

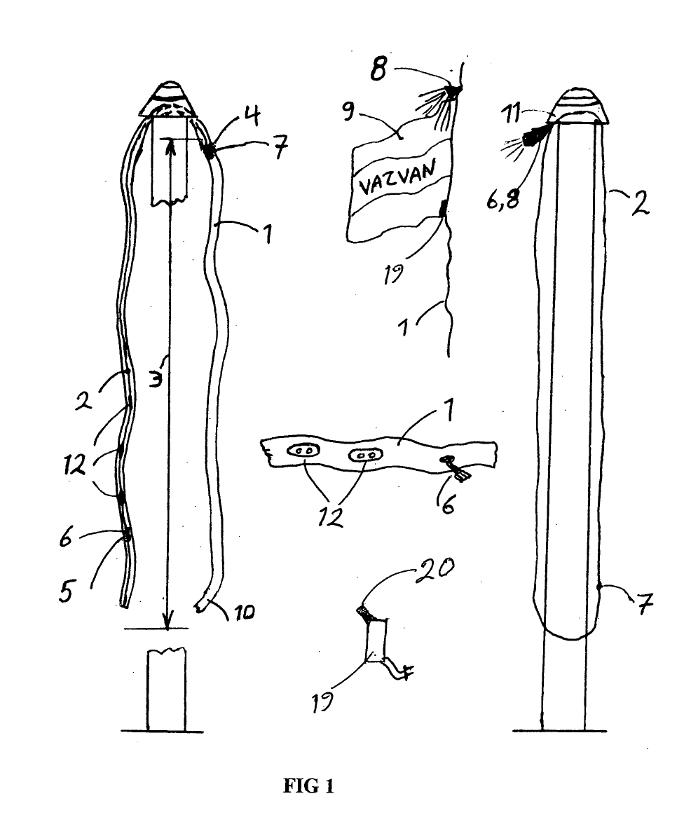

FIG. 2 is an example schematic of the inventive flagpole cleaning device in its few example embodiments.

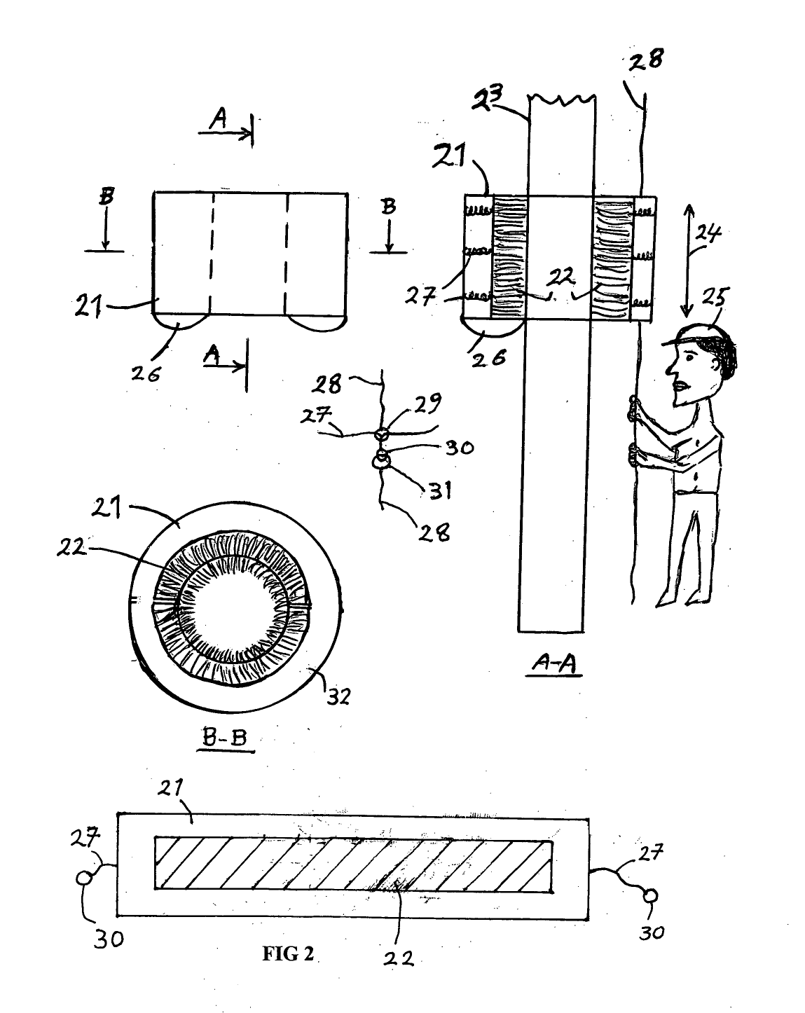

FIG. 3 is an example schematic of the inventive elastic flagpole.

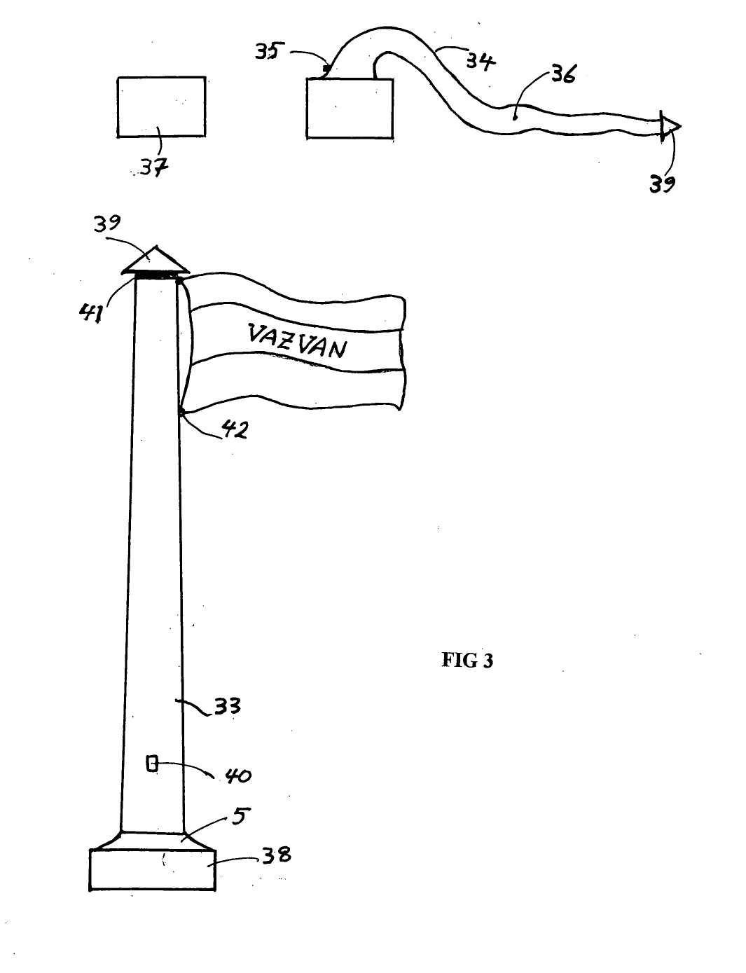

### DETAILED DESCRIPTION OF THE INVENTION

Now the inventions and their several example embodiments will be explained in details. First the inventive smart flag rope. When using the inventive flag rope there is no need to lower the flagpole for changing the bulb etc. of the flag illuminator. There is no need to install any illuminator on the flagpole. The inventive flag rope 1 can be manufactured in different way so that in addition to the conventional materials used in flag ropes it comprises also an electrical/communication cable 2 which is e.g. positioned at the longitudinal axel of the rope at least for a half length of the flag rope 3. When manufacturing said rope said cable can be e.g. even twisted in said rope or e.g. be positioned at the center of the rope as explained. The inventive flag rope can be used in all flagpoles, olds and new ones.

According to the invention said cable 2 is directed out 4 from at least one section (not the end) of said rope 1. The second end of said cable is directed from one end of the rope 5 or from a proper section of said rope e.g. at a desired length. Depending on the applications, appropriate connectors etc. can be connected to the ends 4 and 5 of said cable in order to connect one end of said cable to the electricity power supply and other end to the desired device such as illuminator for illuminating the flag. For example, at the half length of said rope an appropriate connector 7 is connected to said cable 2. This connector can be, for example, connected to the electricity power supply. Then to another section of the rope (at the desired length of the rope) another connector 6 is connected in order to be connected to the desired device such as flag illuminator. Said connectors can be also arranged at certain points 12 of the rope throughout the rope wherein said cable is installed. Said connectors can, for example, be installed in said rope during the manufacturing process of said rope.

For illuminating the flag a low-powered (e.g. 12 volts) illuminator can be used in connection and adjacent to said rope. Said illuminator can be easily attached (e.g. by a proper clamp) to said rope. Said illuminator can be also attached to the flag 9 e.g. under or over the flag. Then by directing the electricity via said rope the illuminator can be turned on without using any separate cable to be installed in or outside of the flagpole. When user draws said rope down form its one end 10 said illuminator goes up along with said rope to the desired level (e.g. top of the) flagpole 11. Then said connector 7 that is connected to half length of said rope comes down and user can easily connect it to the power supply. Since according to the invention said illuminator moves up and down along with said rope the flag is always properly illuminated even when the flag is at half-mast.

The manufacturing method of the said inventive rope is characterized in that during the manufacturing process said cable 2 is positioned into said rope or is twisted/woven etc. with said rope at least for a desired (e.g. half) length 3 of said rope. Additionally, at one section of said rope a proper connector is connected to said cable so that said connector can be safely connected to an electricity power supply or a device such as illuminator.

When said illuminator needs to be repaired, e.g. if its bulb should be changed, it can be easily lowered down by drawing the flag rope. The invention suits to all kind of flagpoles. The inventive flag rope can be used for all kind of devices to be used on flagpoles. For example, at Christmas time an illuminating star can be taken up to the flagpole. At birthday event a “Happy birthday” neon light can be taken up to the flagpole. A lot of applications can be suited to the inventive flag rope. Thanks to this invention, it makes it possible that flagpoles can be used not only for rising flags but also be used for several other purposes.

Said illuminator 8 can include e.g. a bulb/lamp or a number of light diodes etc. For example, said illuminator can be manufactured in a way that a number of light diodes are directed to one side of the flag and another number of light diodes to another side of the flag. It can be also manufactured in a flexible ring or half-ring form in order to be used around the diameter of flagpole. Another advantage of the present invention is that when said illuminator is attached to said rope e.g. one meter under the flag then no one can see said illuminator while the flag is properly illuminated without any extra light prolusion.

According to another object of the present invention the flag can be always beautifully waved even when there is no wind. According to the invention in adjacent of the flag the inventive waver 19 can be attached to said rope 1 or said flag 9. Said waver can be a small, for this purpose designed, electric fan 19. Said fan can be easily directed to the flag so that the flag can be always beautifully waved. Said fan 19 is connected via a connector (e.g. 6, 12) to the inventive rope 1 so that the required electricity power can be always and easily supplied to the fan. The fan is made in a very small size that no one can notice it. In areas where there is no wind the flag does not look beautiful if it is always hanging down with no waving. Thanks to this invention; by using this invention the flag can always look beautiful.

According to the invention said illuminator 8 and flag waver 19 comprise means by which said illuminator 8 or flag waver 19 can be easily and safely attached/detached to/from said rope 1 and be connected to said cable 2 which is installed in said rope 1. Additionally said illuminator 8 and flag waver 19 comprise means (such as ball-and-socket joint) by which said illuminator 8 and flag waver 19 can be easily adjusted and directed to the desired direction. The produced air of said waver can be directed e.g. via a proper tube 20 to the desired direction.

According to the invention all electric devices used in connection with inventive rope 1 can be equipped with a remote receiving devise so that the user can e.g. easily by a wireless remote controller adjust the device parameters (such as power, direction etc.). With or into the inventive rope 1 any kind of cable (such as electricity, communication etc. cable) can be manufactured. The inventive rope 1 can be used on several different purposes (e.g. for base station of a wireless communication system etc.) on the flagpoles.

According to another object of the invention a flagpole washing device is provided that in its one of preferred embodiment uses the inventive flag rope for receiving required power supply. Flagpoles are usually made off metal, plastic or fibreglasses. Outdoor and especially high flagpoles will loose their shine and become dirty in the course of time. In many areas where there is a green environment such as gardens etc. a green alga may appear on the surface of the flagpoles making them very unclean. The dirt of flagpole may also stick to the flag whenever it is risen up. Therefore, flagpoles should be washed and cleaned every now and then. This is a very demanding and costly task since traditionally high flagpoles must be dismounted and lowered down on the ground in order to be washed. After washing, the flagpole must be again mounted in its position. In the course of time the environment around the flagpole may change so much that it is almost impossible to lower down the pole without causing any damages to bushes and trees grown around the pole.

By using the inventive flagpole washing device the flagpole can be washed and polished in few minutes without needing to dismount the flagpole and lower it down on the ground. Furthermore, the inventive device is very economic and can be manufactured in series; there is no need for external electric cables to be attached to the inventive device. In its one embodiment the inventive devise is made of completely elastic material (such as washing sponge etc.) that can be used by anyone easily. The inventive device can be used for all high outdoors flagpoles made of metal, plastic or fibreglasses etc. According to one embodiment of the inventive flagpole washing device, said device 21 is equipped with at least one electrical motor moving e.g. the brushes 22 installed into said device in order to wash and clean the flagpole. In this embodiment said device is connected to a proper connectors 5, 6, 12 of said inventive rope 1 in order to receive the required power supply e.g. from a transformer (no shown) connected to another end 7 of said cable 2 of said rope 1.

According to one preferred embodiments of the invention the device 21 can be hold around the flagpole 23. The flagpole's own rope is used to move said device 21 up and down 24. When user 25 draws the flag rope said device 21 is easily moved up and down washing the flagpole by brushes or washing sponge 22 included into said device 21. Said washing sponge 22 is also used as the washing liquid (e.g. water) container. Additionally, a separate water container 26 can be made e.g. as a part of said device 21. Said device can be made in different embodiments. For example, said washing brushes 22 can be operated (e.g. turned around a proper axel) by a simple electric motor (not shown). Alternatively, said washing sponge 22 can be used to wash the pole manually when user draws the rope up and down. Around said sponge 22 an elastic rope 27 (or other similar mechanism) is used so that when the rope 28 is drawn up and down said elastic rope 27 is drawn around the pole compressing said sponge 22 towards the surface of the flagpole 23. Then while user 24 draws the flagpole's rope 28 up and down and moves it around the pole said flagpole is easily washed. When user positioned the inventive washing device 21 around the flagpole said elastic rope's 27 both ends can be e.g. passed through the ring 29 of the upper part of flag rope 28 and then be attached temporarily by a proper metal or plastic ring 30 to another ring 31 of the another end of said flag rope 28. Then when user draws the flag rope 28 up and down said elastic rope 27 compresses said sponge all around the pole and washes the pole regardless of the different diameters of said flagpole at its different sections.

Usually liquid washing agents developed for flagpoles may include dangerous chemicals that if splashes to the user's face and eyes it must be immediately washed and the user must immediately go to visit a doctor. But with the inventive flag washing device there is no such problem. Any kind of liquid washing agent suitable for flagpoles can be used with said device very securely. For example, for plastic flagpoles any washing agent suitable for plastic surfaces or washing agents used for cleaning fibreglasses boats etc. can be used. While the inner part 22 of said device completely cleans and polishes the surface of the flagpole its outer part does not let the cleaning liquid to flow out or splash around the pole.

According to another subject of this invention a new type of flagpole is provided that removes e.g. the problems of installing the flagpoles. Traditionally, flagpoles are usually made off metal, plastic or fibreglasses, or wood. The problem with such poles is mostly their cost of manufacturing, installations etc. For example, for outdoors flagpole a concrete base must be prepared under the ground. According to this embodiment of the present invention said flagpole 33 is made of flexible and elastic materials such as plastic or rubber that from both ends are closed and it forms a hallow soft tube 34. Said elastic flagpole 33, 34 has a valve 35 for pumping air to the tube (compare e.g. to the vale of a tire of the car). Before said pole is placed in it position it is in a small size 36 that can be also efficiently packed in a small package 37 that can actually form the base 38 of said flagpole 33. When said flagpole is pumped with air (or a proper gas) the head of pole 39 rises up to the sky. At this time said flagpole 33 looks like exactly a normal traditional flagpole. If required, the base 38 of said flagpole can be equipped with means to allow the pole to be fixed or attached to a metal base that can e.g. be used as a weight in order to keep said pole over the ground. Alternatively a separate base can be used that can be easily pushed into the ground to which said elastic pole 33 can be easily fixed. Alternatively, the base 38 of said flagpole can be shaped of a plastic tube (like tire of the car) that can be filled with water etc. to act as a weight in order to keep said flagpole on the ground. The wall thickness of said elastic flagpole 33 is measured to be so strong that when said pole is compressed with air it remains firmly in its position. Alternatively, an air pressure meter 40 can be attached (e.g. during the manufacturing process of said pole) to indicate the air pressure of said pole in order to allow the user to fill said pole with air to a desired and allowable limit. Alternatively, known air pressure meters can be used in connection with said valve 35 when user fill said flagpole 33. To the top 41 of said elastic flagpole a mechanism can be adapted in order to allow any kind of top pieces, such as knobs of flagpoles, be used with inventive flagpole 33. During the manufacturing process, said inventive elastic flagpole 33 can be from inside equipped with required communication or electrical cables. Any connectors to these cables can be integrated to said flagpole 33 during the manufacturing process. For example, if required an illuminator can be fixed to the top 39 of said pole. Since the inventive elastic flagpole 33 can be easily emptied and filled with air therefore said flagpole can be easily lowered in order e.g. to fix said illuminator or any other device. Additionally, since the inventive flagpole can be easily lowered by anyone the flag can be easily attached 42 to top of said pole e.g. by using certain clamps etc. and then rise said flagpole 33, 34 up by pumping air into it. However, said flagpole 33 can be equipped with the traditional flag rope mechanisms and especially with the inventive flag rope 1.

Said inventive flagpole 33, 34 does not need to be in the same position or place all the time. For example for different occasions said flagpole 33, 34 can be easily moved to a desired place and then be pumped with air. Said flagpole 33, 34 can be also made in different colors. It can be also easily transported from a place to another (e.g. from factory to the shops or end users). It is moreover easy to be installed and take care off. Thanks to this invention; anyone can buy even very high of such flagpoles with an economic price and easy installation. Furthermore, for different occasions the flagpole rent companies can easily transport and install the inventive flagpoles to any place required.

The above-mentioned inventions are not restricted to the description above or to the drawings, but can vary within the limits of following claims.

Furthermore, it is worth to be mentioned that the following patent publications has been taken into account in the examination process and national search before the National Board of Patent and Registration Office of Finland for the priority applications of the present inventions. No one of the following publications had any novelty-destroying value to the present invention. Hereby, the following publications are referred as few examples of prior art: US2003193804 (Illuminated pole-suspended flag and method of illuminating), U.S. Pat. No. 6,222,503 (System and method of integrating and concealing antennas, antenna subsystems and communications subsystems), U.S. Pat. No. 6,227,683 (flag-pole light), WO8701755 (device for lighting up flags), JP2000193500 (marine event observing device and mooring composite cable therefore), JP9111679 (reinforcing wire rope having high flexibility and rope reinforced composite material), JP2002205880 (power/signal transmission method utilizing lifting/moving suspension steel wire, its device, elevator, and ropeway), JP9316787 (composite wire rope), DE10065007 (Textile material is made of woven or knitted microfiber combined with light conductors), U.S. Pat. No. 2,858,555 (Self-propelled cleaning or painting device), U.S. Pat. No. 3,116,811 (Portable cable cleaner and lubricator), U.S. Pat. No. 3,344,773 (Flag pole painter), U.S. Pat. No. 4,095,555 (Painting device for flagpoles), U.S. Pat. No. 2,998,801 (Device for painting flagpoles, suspension cables and the like), U.S. Pat. No. 2,357,144 (Surface treating apparatus for poles), JP10337540 (snow pole cleaning machine), JP8074219 (cleaning car for road luminaries).

1. Flag rope (1) for flagpoles characterized in that it includes electricity or communications or the like cable (2) having certain or at least half (3) of the length of said rope allowing a device like illuminator or the like to be connected to one end of said cable (6, 12) and allowing another end of said cable (7) to be connected to an electricity power supply or to any other required device so that when said device (8, 19) is drawn up by using said rope (1) said another end (7) of said cable (2) is can be easily connected to said electricity power supply or other required device.

2. An electric or electronic device like illuminator or the like (8, 19) to be used on flagpoles using a flag rope (1) according to claim 1 characterized in that it is arranged with means to allow said device to be attached to said flag rope (1) and to be connected to said cable (2) of said rope (1).

3. A method for manufacturing flag rope according to claim 1 characterized in that said cable (2) is twisted or woven with said rope (1) or it is put into said rope in the center line of said rope (1) for a certain length, like half length, of said rope (1).

4. A method for manufacturing flag rope according to any preceding claim characterized in that at least to one section or end (6, 12, 7) of said cable is connected a proper connector allowing a device like an illuminator (8, 19) or any other device or equipment to be safely connected to said connector (6, 12, 7).

5. A flagpole cleaning device (21) that can be used in connection with a flagpole using a flag rope for rising and lowering a flag, said device comprising means like washing sponge or soft brash (22) for cleaning said flagpole (23) when said cleaning device (21) is put around said flagpole (23), said device at least in one of its embodiments comprising an electric motor properly and safely connected to the cable (2) of flag rope (1) according to any preceding claim for moving said device (21) or brushes or said device (21) comprising means (27, 30) to be attached to said flag rope or any conventional flag rope (28) in order to allow user (25) to manually moving said device up or down (24) and cleaning said flagpole (23) by pushing and realising said brush or washing sponge (22) towards said flagpole when using said flag rope (28).

6. A flagpole cleaning device (21) according to claim 5 characterized in that a flag rope (28) is used to draw said device up or down over the flagpole (23) while at the same time said flag rope (28), or said flag rope together with an additional auxiliary rope for flagpoles equipped with internal rope system, is used to cause a pushing force to said washing sponge (22) towards the surface of said flagpole (23) as the user (25) is drawing said device (21) up or down, said washing sponge (22) arranged to contain or to be added with a washing agent like water or any other washing liquid so that when said sponge (22) is compressed/pushed around said flagpole (23) said washing liquid is gradually squeezed to the surface of said flagpole (23) in order to wash and clean or shine said flagpole (23) as at the same time a fraction is caused between said sponge (22) and the surface of said flagpole (23).

7. A flagpole cleaning device (21) according to any preceding claim characterized in that an elastic rope (27) or the like is arranged with said washing sponge (22) and the ends (30) of said elastic rope (27) are attached to ends of said flag rope (31) or to said flag rope and said additional rope in order to cause a pushing force to said washing sponge (22) towards the surface of said flagpole (23) as the user (25) is drawing said device (21) up or down (5) using said flag rope (28).

8. A flagpole cleaning device (21) according to any preceding claim characterized in that it is alternatively made of elastic material in one or few parts like washing sponge, PVC fabric, and the like.

9. A flagpole that is at least in one of its embodiments equipped with means to allow using of said flag rope (1) according to any preceding claim characterized in that said flagpole (33, 34) is made of elastic and flexible materials like plastic or rubber forming a soft tube (34) comprising at least a valve (35) in order to allow said tube to be filled with air or a proper gas or other similar in order to form a flagpole (33).

10. A method for manufacturing a flagpole according to claim 9 comprising forming an elastic and flexible flagpole-shaped tube (34) from elastic and flexible materials like plastic or rubber having at least a valve (35) used for pumping air or safe gases or similar into said tube (34) in order to form a flagpole (33) when said tube (34) is properly pumped with said air or similar.
